(19) United States
(12) Patent Application Publication
(10) Pub. No.: US 2008/0158558 A1
(43) Pub. Date: Jul. 3, 2008

(54) Phosphopeptide detection and surface enhanced Raman spectroscopy

(76) Inventors: Handong Li, San Jose, CA (US); Narayan Sundararajan, San Francisco, CA (US)

Correspondence Address: INTEL/BLAKELY, 1279 OAKMEAD PARKWAY, SUNNYVALE, CA, 94085-4040, US

(21) Appl. No.: 11/647,690

(22) Filed: Dec. 28, 2006

(51) Int. Cl. G01J 3/44

(52) U.S. Cl. 356/301

(57) ABSTRACT

Raman-active molecules having specific affinity for phosphorylated peptides and proteins are provided. The Raman-active affinity molecules contain a Raman active group capable of providing a detectable spectrum. The affinity molecules act as tags or reporter molecules and are useful, for example in detecting the presence of a phosphorylated residue in a peptide or protein through the use of SERS spectroscopy. The affinity molecules provide the ability to detect and quantify phosphatase and kinase activities.

### CROSS REFERENCE TO RELATED APPLICATIONS

The present application is related to U.S. patent application Ser. No. 11/395,899, filed Mar. 30, 2006, entitled “Massively Parallel Synthesis of Proteinaceous Biomolecules,” now pending, and U.S. Pat. No. 7,075,642, entitled “Method, Structure, and Apparatus for Rama Spectroscopy,” filed Feb. 24, 2003, the disclosures of which are incorporated herein by reference.

### BACKGROUND OF THE INVENTION

1. Field of the Invention

The embodiments of the present invention relate generally to Raman active molecules and affinity ligands, the detection of phosphorylated peptides and proteins, surface enhanced Raman spectroscopy, and Raman enhancement active substrates comprising arrays of peptides.

2. Background Information

The phosphorylation of peptides and proteins in vivo is an important biochemical function. It is estimated that about 30% of all proteins in mammalian cells are phosphorylated at any given time and that about 5% of a vertebrate genome encodes protein kinases (enzymes that catalyze the phosphorylation of serine, threonine, or tyrosine groups in enzymes and other proteins using adenosine triphosphate (ATP) as a phosphate donor) and phosphatases (enzymes that catalyze the removal of phosphate groups that have been attached to amino acid residues of proteins and peptides by protein kinases). Phosphorylation, for example, forms the foundation of intracellular signaling networks and specific protein kinases regulate enzymes catalyzing key reactions in processes such as glycogen turnover, cholesterol biosynthesis, and amino acid transformations by phosphorylation. Qualitative and quantitative information are crucial to a detailed understanding of the function of protein phosphorylation in biological systems. Liquid Chromatography and Mass Spectrometry (MS) are now becoming a quantitative approach to analyze protein phosphorylation. However, there are several difficulties associated with the detection of phosphate groups. Phosphate groups are labile in general and also tend to be labile during MS analysis. Enzymatic digestion of phosphopeptides often generates short phosphopeptides that do not retain on a column to allow good separation. For these reasons, sensitivity in Mass Spectrometry has been found to be lacking for examining phosphorylation stoichiometries.

Among the many analytical techniques that can be used for chemical analyses, surface-enhanced Raman spectroscopy (SERS) has proven to be a sensitive method. A Raman spectrum, similar to an infrared spectrum, consists of a wavelength distribution of bands corresponding to molecular vibrations specific to the sample being analyzed (the analyte). Raman spectroscopy probes vibrational modes of a molecule and the resulting spectrum, similar to an infrared spectrum, is fingerprint-like in nature. As compared to the fluorescent spectrum of a molecule which normally has a single peak exhibiting a half peak width of tens of nanometers to hundreds of nanometers, a Raman spectrum has multiple structure-related peaks with half peak widths as small as a few nanometers.

To obtain a Raman spectrum, typically a beam from a light source, such as a laser, is focused on the sample generating inelastically scattered radiation which is optically collected and directed into a wavelength-dispersive spectrometer. Although Raman scattering is a relatively low probability event, SERS can be used to enhance signal intensity in the resulting vibrational spectrum. Enhancement techniques make it possible to obtain a 10⁶ to 10¹⁴ fold Raman signal enhancement.

Surface enhanced Raman scattering from an analyte has been observed when metal nanoparticles are aggregated. It has been reported that silver particle sizes within the range of 50-100 nm are most effective for SERS. Theoretical and experimental studies also reveal that metal particle junctions are sites for efficient SERS. Usually, negatively charged nanoparticles aggregate in presence of salts. For example, lithium chloride has been shown to cause the negatively charged silver Raman particles to aggregate to generate hot spots for the detection of target molecules such as deoxyadenosine monophosphate (dAMP). A single dAMP molecule can be detected. See, for example, U.S. Patent Application Publication No. 20040179195, “Chemical Enhancement in Surface Enhanced Raman Scattering Using Lithium Salts,” and U.S. Patent Application Publication Nos. 20040179195 and 20050147979, “Nucleic Acid Sequencing by Raman Monitoring of Uptake of Nucleotides During Molecular Replication.”

### BRIEF DESCRIPTION OF THE FIGURES

FIG. 1 provides the structural drawings for some exemplary molecules having a phospho affinity ligand and a Raman label.

FIG. 2 provides an exemplary synthetic route for a molecule having a phospho affinity ligand and a Raman label.

FIG. 3 shows a diagram of an affinity Raman tagging and detection platform and a method of use to perform enzyme activity screenings and detect phosphorylated peptides.

### DETAILED DESCRIPTION OF THE INVENTION

Embodiments of the invention provide molecules that are useful for the detection of peptides and proteins that have been phosphorylated. Embodiments of the invention integrate the sensitive SERS technique and biochemical affinity tagging. Molecules that are Raman and or SERS active are coupled to a ligand that possesses a specific affinity for phosphate groups. This invention permits direct detection of phosphate groups attached to tyrosine, serine, or threonine residues of peptides and or proteins in solution or attached to solid substrates, thereby providing a tool for identifying, for example, kinase targets in signal transduction pathways and for phospho proteomics studies. Embodiments of the present invention can be integrated into applications involving drug screening, drug efficacy, and disease prognosis analysis.

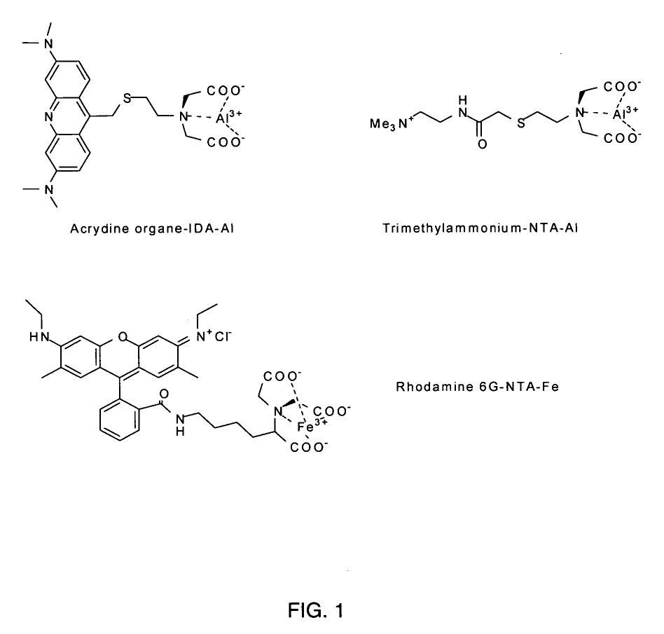

Referring now to FIG. 1, several exemplary structures containing a phospho affinity ligand and a Raman tag molecule are depicted. In general, the phospho affinity ligand Raman tag molecule can be represented by the following structure: R-L-M, in which R is a Raman tag or label, L is a linker molecule, and M is a phospho affinity ligand. The phospho affinity ligand specifically recognizes and binds to phosphate groups attached to tyrosine, serine, or threonine residues on peptides and or proteins. As described more fully herein, a Raman tag molecule is typically an organic molecule that is capable of producing a measurable surface enhanced Raman spectrum. In the examples shown in FIG. 1, the Raman tag is a trimethylammonium, a Rhodamine 6G, or an acridine orange molecule. In general, a linker is any non-charged, hydrophilic structure, such as for example, ether or amide-containing structures. The phospho affinity ligand comprises a chelating group and a metal ion. The chelating group is typically a tridentate, quadradentate, or pentadentate ligand, in that the ligand comprises three to five metal coordinating sites. The metal coordinating sites may coordinate a metal ion through, for example, a nitrogen, such as with an ammonium, imino, nitrilo, pyridinyl, pyrazolyl, imidazolyl, and or isocyanidyl group, and or an oxygen, such as a carboxy, hydroxy, ether, and or keto. Suitable metal ions include those having a valency of 2⁺ or 3⁺. Useful metal ions include for example, Al³⁺, Fe³⁺, Cu²⁺, Ni²⁺, Zn²⁺, Co²⁺, Sc³⁺, Lu³⁺, Th³⁺, and Ga³⁺. Examples of chelating groups include iminodiacetate, tris(carboxymethyl)ethylene diamine, and nitrilotriacetic acid (substituted in the alpha position by an alkyl group having about 1 to 30 carbon atoms).

The attachment of the phospho affinity ligand to the protein or peptide that is phosphorylated allows the phosphate group to be detected using SERS through the observation of the SERS spectrum of the Raman active molecule. A SERS spectrum is typically observed by associating a SERS-active molecule, label, or tag with a SERS-active material. SERS-active materials include, for example, metal nanoparticles, metal surfaces, porous metal surfaces, surfaces coated with metals, and porous metal-coated surfaces. Metals useful for SERS analyses include, for example, silver, gold, platinum, palladium, rhodium, nickel, aluminum, and copper. Especially large SERS enhancements are frequently observed with gold and silver surfaces. As described more fully herein, large enhancements have also been observed for metal surfaces in the presence of lithium chloride (LiCl). In general, the phosphorylated peptide or protein to be detected can be in solution, part of a cell surface or membrane, and or attached to a solid support.

Table 1 provides examples of organic compounds that can function as Raman labels (tags or reporters). In general, Raman-active organic compound (label, tag, or reporter molecule) refers to an organic molecule that produces a unique detectable SERS signature in response to excitation by a laser. Typically the Raman-active compound has a molecular weight less than about 500 Daltons.

TABLE 1

| Compound Name | Structure |
|---|---|
| 8-Aza-adenine | 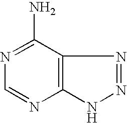 |
| 2-Mercapto-benzimidazole | 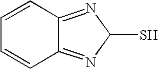 |
| 4-Amino-pyrazolo[3,4-d]pyrimidine | 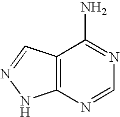 |
| 9-Amino-acridine | 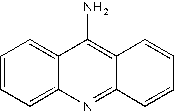 |
| Ethidium Bromide | 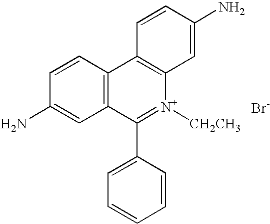 |
| Bismarck Brown Y | 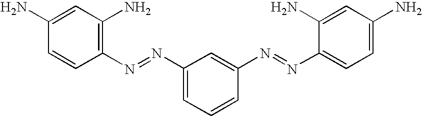 |
| Thionin acetate | 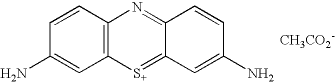 |
| 3,6-Diaminoacridine | 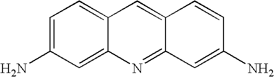 |
| Rhodamine 6G | 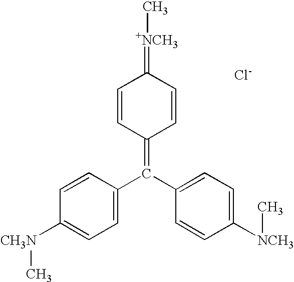 |
| 9-Aminofluorene hydrochloride | 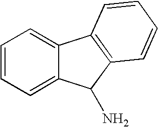 |
| 2-Amino-benzothiazole | 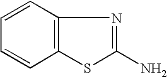 |
| 2-Aminopurine | 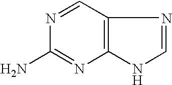 |
| Adenine Thiol | 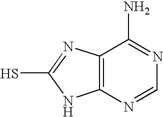 |
| Fluoroadenine | 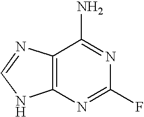 |
| 6-Mercaptopurine | 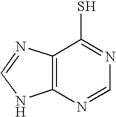 |
| Rhodamine 110 | 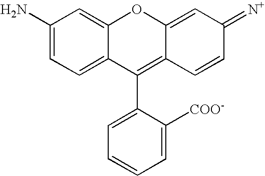 |

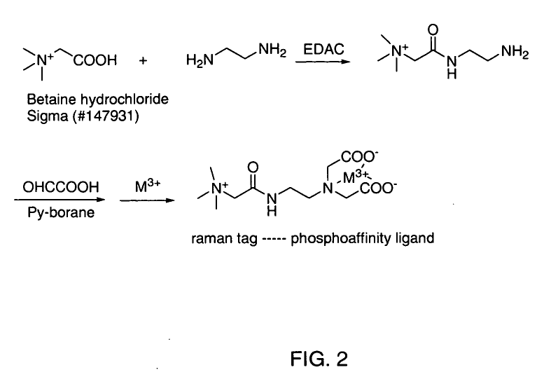

FIG. 2 provides a scheme for the synthesis of a molecule comprising both a phospho affinity ligand and a Raman active label. In this example, a Raman active phospho affinity ligand is synthesized having a trimethylammonium Raman reporter group attached to a chelated metal group. The chelated metal ion group is capable of specifically binding to phosphate groups. In general, standard coupling schemes known in the art can be used to create phosphate-group specific labels, such as couplings between carboxylic acid groups and amines and thiol group derivatizations. See, for example, Xin Li, Kevin S. J. Thompson, Ben Godber, Matthew A. Cooper, “Quantification of Small Molecule-Receptor Affinities and Kinetics by Acoustic Profiling,” ASSAY and Drug Development Technologies, Oct. 2006, Vol. 4, No. 5: 565-573.

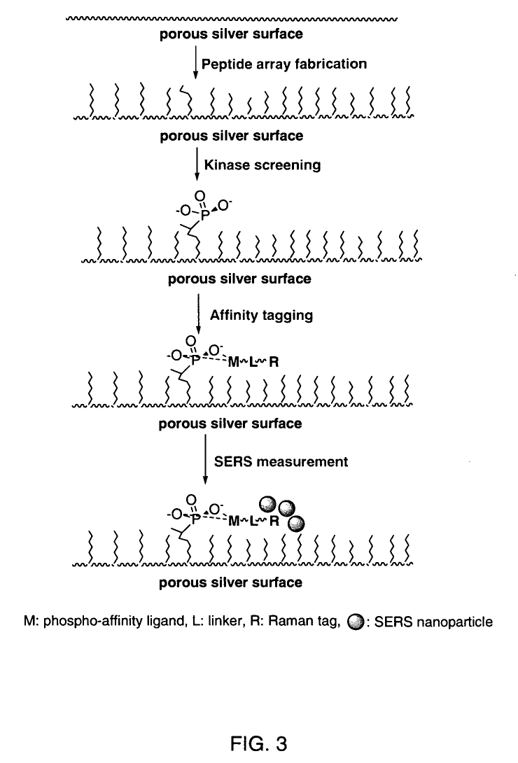

FIG. 3 provides a schematic diagram of an affinity Raman tagging and detection platform. An array of peptides is synthesized, spotted, or printed on a porous surface. In this example, the porous surface is a porous silver surface. In general, a porous metal surface can comprise a metal layer on a porous surface where the porous surface is plastic, glass, silicon, silicon dioxide, silicon nitride, or another material as described more fully herein. An assay is performed, such as for example, a kinase screening assay. Any peptides on the array that have been phosphorylated as a result of the enzyme assay are then tagged using an affinity tagging ligand, R-L-M. The surface of the array is washed to remove any uncomplexed affinity tags, and a SERS measurement is performed to detect the presence of phosphorylated peptides. Optionally, after any uncomplexed affinity tags have been removed, SERS active metal nanoparticles may be added to the array to increase the Raman enhancement observed for the Raman tag(s). Also optionally, the SERS measurement may be performed in the presence of LiCl. For example, the LiCl may be added as a solution to the surface of the array after phospho affinity tag attachment, after metal nanoparticle deposition, or metal nanoparticles can be deposited from a solution comprising LiCl. Further, as described herein, the porous Raman active silver surface may further comprise a neutral, hydrophobic, ultra-thin layer to reduce background and or increase specificity. Concentrations of phosphorylated peptides and proteins are determined through the comparison of measured Raman signal intensities with intensities from standard solutions or substrates containing known amounts of phosphorylated peptides and or proteins.

In general, peptides are polymers of amino acids, amino acid mimics or derivatives, and/or unnatural amino acids. The amino acids can be any amino acids, including α, β, or ω-amino acids and modified amino acids. When the amino acids are a-amino acids, either the L-optical isomer or the D-optical isomer may be used. In general, an amino acid contains an amine group, a carboxylic group, and an R group. The R group can be a group found on a natural amino acid or a group that is similar in size to a natural amino acid R group. Additionally, unnatural amino acids, for example, β-alanine, phenylglycine, homoarginine, aminobutyric acid, aminohexanoic acid, aminoisobutyric acid, butylglycine, citrulline, cyclohexylalanine, diaminopropionic acid, hydroxyproline, norleucine, norvaline, ornithine, penicillamine, pyroglutamic acid, sarcosine, and thienylalanine are also contemplated by the embodiments of the invention. These and other natural and unnatural amino acids are available from, for example, EMD Biosciences, Inc., San Diego, Calif.

A peptide is a polymer in which the monomers are amino acids, a group of molecules which includes natural or unnatural amino acids, amino acid mimetics, and amino acid derivatives, which are generally joined together through amide (peptide) bonds. A peptide can alternatively be referred to as a polypeptide. Peptides contain two or more amino acid monomers, and often more than 50 amino acid monomers (building blocks).

A protein is a long polymer of amino acids linked via peptide bonds and which may be composed of one or more polypeptide chains. More specifically, the term protein refers to a molecule comprised of one or more polymers of amino acids. Proteins are essential for the structure, function, and regulation of the body's cells, tissues, and organs. Different types of proteins have unique functions. Examples of proteins include some hormones, enzymes, and antibodies.

Peptides and proteins to be analyzed may be attached to surfaces that include glass or plastic beads or magnetic particles. Additionally, the peptide or protein to be analyzed may be part of a cell surface membrane. The glass or plastic beads may optionally be porous and or coated with a Raman-active metal. An assay can be performed using the beads or particles, such as a kinase or phosphatase assay, and a Raman tag attached to any phosphorylated peptides or proteins. Any uncomplexed Raman tags can be separated from the Raman tag-phosphopeptide or -phosphoprotein complexes, for example, through centrifugation of the beads or cells or magnetic separation of the magnetic particles (if magnetic particles have been used). Raman tags that are complexed to phosphorylated proteins can then be associated with a Raman-active surface (such as a gold or silver metal surface) and detected by Raman spectroscopy.

An array is an intentionally-created collection of molecules situated on a solid support in which the identity or source of a group of molecules is known based on its location on the array. The molecules housed on the array and within a feature of an array can be identical to or different from each other.

The features, regions, or sectors of an array in which the bio-polymers are located may have any convenient shape, for example, the features of the array may be circular, square, rectangular, elliptical, or wedge-shaped. In some embodiments, the region in which each distinct biomolecule is synthesized within a feature is smaller than about 1 mm², or less than 0.5 mm². In further embodiments the features have an area less than about 10,000 μm² or less than 2.5 μm². Additionally, multiple copies of a polymer will typically be located within any feature. The number of copies of a polymer can be in the thousands to the millions within a feature. Features may contain homogeneous or heterogeneous polymer compositions. In a homogeneous polymer composition at least 50% of the polymers within the feature are identical. In a heterogeneous polymer composition, less than 50% of the polymers within a feature are identical. In general, an array can have any number of features, and the number of features contained in an array may be selected to address such considerations as, for example, experimental objectives, information-gathering objectives, and cost effectiveness. An array could be, for example, a 20×20 matrix having 400 regions, 64×32 matrix having 2,048 regions, or a 640×320 array having 204,800 regions. Advantageously, the present invention is not limited to a particular size or configuration for the array.

Advantageously, embodiments of the present invention are not limited by the method by which the arrays of peptides or proteins are created, and many types of arrays may be used. For example, an array may include peptides that have been synthesized in situ on a solid support. Methods for solid-phase array synthesis include photolithographic methods and light-directed synthetic methods. Solid-phase polymer synthesis can be accomplished in a manner that provides controlled-density microarrays comprised of peptides, peptoids, peptidemimetics, branched peptides, and or other small bio-molecules. Additionally, the solid-phase semiconductor lithographic array synthesis methods are highly scalable for array manufacture on a wafer or chip similar to those used to fabricate devices in the semiconductor industry. Additionally, arrays may be formed by spotting or printing the desired peptide and or protein samples onto a surface.

In general, solid-phase photolithographic polymer synthesis can be accomplished using semiconductor lithographic techniques. In these methods a first amino acid or linker molecule is attached to the surface of a solid substrate. The first molecule contains a peptide-bond forming group that is protected by a protecting group (such as for example, a t-butoxycarbonyl (t-BOC)), 2-(4-biphenylyl)-2-oxycarbonyl, or fluorenylmethoxycarbonyl (FMOC) group). A protecting group is a group which is bound to a molecule and designed to block a reactive site in a molecule, but may be removed upon exposure to an activator or a deprotecting reagent. A photoresist comprising a polymer, a photosensitizer, and a photo-active compound or molecule in a solvent. The photoresist can be applied using any method known in the art of semiconductor manufacturing for the coating of a wafer with a photoresist layer, such as for example, the spin-coating method. The photoresist is then patterned with light. The light activates the photo-active compound in the photoresist and removes the protective groups in the regions of the array that receive light. Removal of the photoresist removes protecting groups in the patterned regions. A next amino acid can be coupled to the deprotected first molecules. The amino acid to be coupled comprises a protecting group. This procedure is repeated to build polymers on the substrate surface. Useful photo-activated catalysts for protective group removal include for example, acids that can be generated photochemically from sulfonium salts, halonium salts, and polonium salts. Sulfonium ions are positive ions, R₃S⁺, where R is, for example, a hydrogen or alkyl group, such as methyl, phenyl, or other aryl group, for example, trimethyl sulfonium iodide and triaryl sulfonium hexafluroantimonatate (TASSbF₆). In general, halonium ions are bivalent halogens, R₂X⁺, where R is a hydrogen or alkyl group, such as methyl, phenyl, or other aryl group, and X is a halogen atom. The halonium ion may be linear or cyclic. Polonium salt refers to a halonium salt where the halogen is iodine, the compound R₂I⁺Y⁻, where Y⁻ is an anion, for example, a nitrate, chloride, or bromide ion. For example, diphenyliodonium chloride and diphenyliodonium nitrate are useful. See also, for example, U.S. patent application Ser. No. 11/395,899, filed Mar. 30, 2006, entitled “Massively Parallel Synthesis of Proteinaceous Biomolecules.”

Arrays of peptides may also be created on a solid substrate surface through light-directed synthesis. Peptides are formed on the substrate in a similar manner to the photolithographic methods described herein, however the removal of the protecting group is a light-driven process (i.e., the protecting groups are photoremovable). The array is patterned with light during synthesis, but no photoresist is used. Photo-patterning of the substrate, photoremoval of protecting groups, and coupling of a protected amino acids are repeated to build polymers on the substrate surface. See for example, U.S. Pat. Nos. 5,143,854 and 6,506,558.

Solid support, support, and substrate refer to a material or group of materials having a rigid or semi-rigid surface or surfaces. In some aspects, at least one surface of the solid support will be substantially flat, although in some aspects it may be desirable to physically separate synthesis regions for different molecules with, for example, wells, raised regions, pins, etched trenches, or the like. In certain embodiments, the solid support may be porous.

Substrate materials useful in embodiments of the present invention include, for example, silicon, bio-compatible polymers such as, for example poly(methyl methacrylate) (PMMA) and polydimethylsiloxane (PDMS), glass, SiO₂ (such as, for example, a thermal oxide silicon wafer such as that used by the semiconductor industry), quartz, silicon nitride, functionalized glass, gold, platinum, and aluminum. Functionalized surfaces include for example, amino-functionalized glass, carboxy functionalized glass, and hydroxy functionalized glass. Additionally, a substrate may optionally be coated with one or more layers to provide a surface for molecular attachment or functionalization, increased or decreased reactivity, binding detection, or other specialized application. Substrate materials and or layer(s) may be porous (as described more fully herein) or non-porous. For example, a substrate may be comprised of porous silicon. Further, substrates, including porous substrates, may be coated with a SERS-active metal layer in order to, for example, enhance SERS detection.

Substrates or solid surfaces useful for attaching peptides and or forming arrays include porous materials. Suitable porous materials include porous silicon (e.g., single crystal porous silicon), porous polysilicon, porous ceramics (e.g., those made from fibrous porous silicon nitride), porous silica, porous alumina, porous silicon-germanium, porous germanium, porous gallium arsenide, porous gallium phosphide, porous zinc oxide, and porous silicon carbide. Methods of making such porous materials are generally known. See, for example, Dougherty et al. (2002) Mat. Res. Soc. Symp. Proc. 687:B.7.3.1-B.7.3.6 (porous polysilicon), Ohji (2001) AIST Today 1:28-31 (porous ceramics), Trau et al. (1997) Nature 390:674-676 (porous silica), Masuda et al. (1995) Science 268:1466-1468 (porous alumina), Li et al. (1999) Adv. Mater. 11:483-487 (porous alumina), Nielsch et al. (2000) Adv. Mater. 12:582-586 (porous alumina), Buttard et al. (1997) Thin Solid Films 297:233-236 (porous silicon-germanium), van Vugt et al. (2002) Chem Commun. 2002:2054-2055 (porous germanium), Kamenev et al. (2000) Semiconductors 34:728-731 (porous gallium arsenide), Buzynin et al. (2000) Tech. Physics 45:650-652 (porous gallium arsenide), Shuurmans et al. (1999) Science 284:141-143 (porous gallium phosphide), Lubberhuizen et al. (2000) J. Porous Mat. 7:147-152 (porous gallium phosphide), Terada et al. (1999) 4th Int'l. Conf. on Ecomaterials P-30:559-562 (porous zinc oxide), Jessensky et al. (1997) Thin Solid Films 297:224-228 (porous silicon carbide), Spanier et al. (2000) Appl. Phys. Lett. 76:3879-3881 (porous silicon carbide), Spanier et al. (2000) Physical Review B 61:10437-10450 (porous silicon carbide), and Sangsig et al. (2000) Jpn. J. Appl. Phys. 39:5875-5878 (porous silicon carbide). The substrate can include a plurality of layers of the porous material.

Porous silicon is a material that can be made simply and inexpensively. As observed by high resolution scanning and transmission electron microscope, porous silicon typically has pore diameters varying from a few nanometers to several micrometers, depending upon the conditions under which the porous silicon was formed. The term “porous” as used herein may be defined consistent with the IUPAC guidelines, wherein “microporous” refers to pores having a size regime that is less than or equal to two nanometers (nm), “mesoporous” refers to pores having a size regime that is between about 2 and 50 nm, and “macroporous” refers to pores having a size regime that is greater than about 50 nm. See e.g., Cullis et al. (1997) J. Appl. Phys. Rev. 82:909-965. Porous materials, such as porous silicon, may be made by many different techniques, the most common of which is one using electrochemistry because a relatively large and relatively homogeneous substrate can be readily formed by such technique. While porous silicon substrates can be prepared by a variety of techniques, such as, for example, stain etching and anodic etching, preferably, porous silicon substrates are prepared by anodic electrochemical etching. Anodic electrochemical etching permits control of properties of the formed substrate such as, for example, microstructure, pore diameter, porosity, refractive index, and thickness. Anodic electrochemical etching includes immersing an electrode (e.g., a platinum electrode) and a silicon wafer in an electrolytic bath containing, for example, water, ethanol, and hydrofluoric acid (HF), or solutions of hydrogen nitrate (HNO₃) in HF. While in solution, the wafer is subjected to a constant current in a range of about 1 mA/cm² to about 1000 mA/cm². The current is applied to the wafer for a time period ranging from several seconds to several hours, preferably for up to about one hour, to form a layer of porous silicon at or on the surface of the wafer. Etching and anodization can occur with or without illumination depending upon the type of substrate dopant.

Embodiments of the invention include peptide and or protein arrays on a porous Raman surface. The porous Raman surface could be fabricated by layering a substrate, with a Raman active metal and then with a functional layer. The porous substrate could be, as described herein, silicon (e.g., single crystal porous silicon), porous polysilicon, porous ceramics (e.g., those made from fibrous porous silicon nitride), porous silica, porous alumina, porous silicon-germanium, porous germanium, porous gallium arsenide, porous gallium phosphide, porous zinc oxide, and porous silicon carbide, glass, or plastic. In general, a functional layer is a material that is suitable for peptide and protein immobilization by either in situ array synthesis or array spotting. In general, a functional layer material is selected to have hydrophilic and neutral properties to prevent non-specific binding. The functional material layer thickness can be controlled to be thin or just a monomolecular layer to render the maximum Raman enhancement. Examples of functional layer materials include, but are not limited to, dextran, polyvinyl alcohol, polyethylene glycol, and functional polyacrylamide derivatives (functionalized, for example, with hydroxyl groups).

Raman signal enhancement of the Raman active phospho affinity ligand occurs through the association of the ligand with a Raman active metal surface. This metal surface can be part of an array, a metal nanoparticle surface, or both. Raman active metals include, for example, silver, gold, platinum, palladium, rhodium, nickel, aluminum, and copper. Especially large SERS enhancements have been observed with gold and silver surfaces. Optionally, Raman enhancements may be achieved through the use of lithium chloride (LiCl) in conjunction with the Raman active metal surface. For example, lithium chloride may be added to a silver nanoparticle solution at a final concentration of 0.18 M and the silver nanoparticle solution placed in contact with the phospho affinity ligand in order to enhance the Raman signal from the ligand. See for example, U.S. Pat. No. 7,019,828, entitled “Chemical Enhancement in Surface Enhanced Raman Scattering Using Lithium Salts.”

In the practice of embodiments of the present invention, a Raman spectrometer can be part of a detection unit designed to detect and quantify phosphopeptides labeled with Raman tags by Raman spectroscopy. Methods for detection of Raman labeled analytes, for example nucleotides, using Raman spectroscopy are known in the art. See, for example, U.S. Pat. Nos. 5,306,403; 6,002,471; and 6,174,677. A non-limiting example of a Raman detection unit is disclosed in U.S. Pat. No. 6,002,471. An excitation beam is generated by either a frequency doubled Nd:YAG laser at 532 nm wavelength or a frequency doubled Ti:sapphire laser at 365 nm wavelength. Pulsed laser beams or continuous laser beams may be used. The excitation beam passes through confocal optics and a microscope objective, and is focused onto the flow path and/or the flow-through cell. The Raman emission light from the labeled nanoparticles is collected by the microscope objective and the confocal optics and is coupled to a monochromator for spectral dissociation. The confocal optics includes a combination of dichroic filters, barrier filters, confocal pinholes, lenses, and mirrors for reducing the background signal. Standard full field optics can be used as well as confocal optics. The Raman emission signal is detected by a Raman detector, which includes an avalanche photodiode interfaced with a computer for counting and digitization of the signal.

Another example of a Raman detection unit is disclosed in U.S. Pat. No. 5,306,403, including a Spex Model 1403 double-grating spectrophotometer with a gallium-arsenide photomultiplier tube (RCA Model C31034 or Burle Industries Model C3103402) operated in the single-photon counting mode. The excitation source includes a 514.5 nm line argon-ion laser from SpectraPhysics, Model 166, and a 647.1 nm line of a krypton-ion laser (Innova 70, Coherent).

Alternate excitation sources include a nitrogen laser (Laser Science, Inc.) at 337 nm and a helium-cadmium laser (Liconox) at 325 nm (U.S. Pat. No. 6,174,677), a light emitting diode, an Nd:YLF laser, and/or various ions lasers and/or dye lasers. The excitation beam may be spectrally purified with a bandpass filter (Corion) and may be focused on the flow path and/or flow-through cell using a 6× objective lens (Newport, Model L6×). The objective lens may be used to both excite the Raman-active organic compounds and to collect the Raman signal, by using a holographic beam splitter (Kaiser Optical Systems, Inc., Model HB 647-26N18) to produce a right-angle geometry for the excitation beam and the emitted Raman signal. A holographic notch filter (Kaiser Optical Systems, Inc.) may be used to reduce Rayleigh scattered radiation. Alternative Raman detectors include an ISA HR-320 spectrograph equipped with a red-enhanced intensified charge-coupled device (RE-ICCD) detection system (Princeton Instruments). Other types of detectors may be used, such as Fourier-transform spectrographs (based on Michaelson interferometers), charged injection devices, photodiode arrays, InGaAs detectors, electron-multiplied CCD, intensified CCD and/or phototransistor arrays.

Any suitable form or configuration of Raman spectroscopy or related techniques known in the art may be used for detection of the nanoparticles of the present invention, including but not limited to normal Raman scattering, resonance Raman scattering, surface enhanced Raman scattering, surface enhanced resonance Raman scattering, coherent anti-Stokes Raman spectroscopy (CARS), stimulated Raman scattering, inverse Raman spectroscopy, stimulated gain Raman spectroscopy, hyper-Raman scattering, molecular optical laser examiner (MOLE) or Raman microprobe or Raman microscopy or confocal Raman microspectrometry, three-dimensional or scanning Raman, Raman saturation spectroscopy, time resolved resonance Raman, Raman decoupling spectroscopy or UV-Raman microscopy.

Embodiments of the invention can be integrated into applications involving, for example, drug screening, drug efficacy, and disease prognosis analysis. Examples of applications include but not limited to, (1) identification of kinase substrate peptides, (2) detection of potential phosphorylation sites in substrate proteins, (3) determination of auto-phosphorylation sites, (4) identification of upstream kinases for target proteins, and (5) elucidation of signal transduction pathways. In a kinase screening assay, for example, an array of peptides is provided upon which a selected kinase enzyme may or may not be active toward phosphorylating. The kinase is washed over the surface of the array under conditions that allow the kinase to phosphorylate peptides that are substrates for the kinase enzyme. Any peptides that are phosphorylated as a result of the kinase activity are detected through affinity Raman tagging. Similarly, a phosphatase assay is performed by providing an array of phosphorylated peptides upon which the selected phosphatase enzyme may or may not be active toward de-phosphorylating. The phosphatase enzyme is washed over the surface of the array under conditions that allow the phosphorylase enzyme to dephosphorylate peptides that are substrates for the phosphorylase enzyme. Any peptides that are dephosphorylated as a result of the phosphorylase activity are detected through affinity Raman tagging (the dephosphorylated peptides will not be tagged whereas the unreacted phosphorylated peptides will be tagged).

What is claimed is:

1. A method for detecting a phosphorylated peptide or protein comprising,
contacting a sample comprising a phosphorylated peptide or protein with a Raman active phospho affinity molecule, wherein the Raman active phospho affinity molecule comprises a phospho affinity ligand capable of binding to a phosphate group and a Raman active group capable of providing a detectable SERS spectrum, under conditions that allow the Raman active phospho affinity molecule to selectively bind to the phosphorylated peptide or protein,
separating the phosphorylated peptide or protein from any uncomplexed Raman active phospho affinity molecules, detecting a surface enhanced Raman signal from the Raman active phospho affinity molecule wherein the surface enhanced Raman signal from the Raman active phospho affinity molecule is indicative of the presence of a phosphorylated peptide or protein.

2. The method of claim 1 wherein the Raman active group is an organic group having a molecular weight less than 500 Daltons.

3. The method of claim 1 wherein the detecting a surface enhanced Raman signal includes associating the phosphorylated peptide or protein Raman active phospho affinity molecule complex with a surface enhanced Raman active metal surface.

4. The method of claim 3 wherein the surface enhanced Raman active metal surface comprises a porous surface.

5. The method of claim 3 or 4 wherein the metal of the surface enhanced Raman active metal surface is silver or gold.

6. The method of claim 1 wherein the detecting a surface enhanced Raman signal includes depositing Raman active metal nanoparticles on the surface of the array.

7. The method of claim 6 wherein the Raman active metal nanoparticles are silver or gold nanoparticles and the Raman active metal nanoparticles also include LiCl.

8. The method of claim 1 wherein the phospho affinity ligand is comprised of a chelated metal ion.

9. The method of claim 8 wherein the chelated metal ion is selected from the group consisting of Al³⁺, Fe³⁺, Cu²⁺, Ni²⁺, Zn²⁺, Co²⁺, Sc³⁺, Lu³⁺, Th⁺, and Ga³⁺.

10. The method of claim 8 or 9 wherein the chelated metal ion is chelated by a tridentate, a quadradentate, or a pentadentate metal ion chelating ligand.

11. The method of claim 1 wherein separating the phosphorylated peptide or protein from any uncomplexed Raman active phospho affinity molecules comprises washing the uncomplexed Raman active phospho affinity molecules from the surface of an array.

12. A Raman active surface comprising a substrate having a porous surface, a Raman-active metal layer disposed on the porous surface of the substrate, and an array of peptides attached to the Raman-active metal layer wherein the array of peptides comprises at least 100 features.

13. The Raman active surface of claim 12 wherein the substrate is selected from the group consisting of glass, plastic, silicon, silicon dioxide, and silicon nitride.

14. The Raman active surface of claim 12 wherein the Raman-active metal layer is selected from the group consisting of silver, gold, copper, aluminum, platinum, palladium, and rhodium.

15. The Raman active surface of claim 12 wherein the Raman-active metal layer is selected from the group consisting of silver and gold.

16. The Raman active surface of claim 12 wherein at least one feature of the array comprises a peptide capable of being phosphorylated by a kinase enzyme.

17. The Raman active surface of claim 12 wherein at least one feature of the array comprises a phosphorylated peptide capable of being dephosphorylated by a phosphatase enzyme.

18. The Raman active surface of claim 12 additionally comprising a neutral hydrophobic layer disposed between the Raman active metal and the peptide.

19. A method for detecting kinase or phosphatase activity comprising,
providing an array of peptides or proteins on a porous surface comprising a Raman-active metal layer,
contacting a sample comprising a phosphatase or kinase enzyme with the array of peptides under conditions that allow the phosphatase or kinase enzyme to modify peptides or proteins of the array, contacting the array of peptides with a Raman active phospho affinity molecule wherein the Raman active phospho affinity molecule comprises a phospho affinity ligand capable of binding to a phosphate group and a Raman active group capable of providing a distinctive surface enhanced Raman spectrum, under conditions that allow the Raman active phospho affinity molecules to selectively bind phosphorylated peptides or proteins,
separating any uncomplexed Raman active phospho affinity molecules from the array,
detecting a surface enhanced Raman signal from a phosphorylated peptide or protein wherein the detection of a distinctive surface enhanced Raman spectrum of the Raman active phospho affinity molecule is indicative of the presence a phosphorylated peptide or protein on the array.

20. The method of claim 19 wherein the array comprises at least 100 features.

21. The method of claim 19 wherein the array comprises at least 100 features and the features each comprise a unique homogeneous peptide composition.

22. The method of claim 19 wherein the Raman-active metal layer comprises silver or gold.

23. The method of claim 19 wherein the phospho affinity ligand is comprised of a chelated metal ion.

24. The method of claim 23 wherein the chelated metal ion is selected from the group consisting of Al³⁺, Fe³⁺, Cu²⁺, Ni²⁺, Zn²⁺, Co²⁺, Sc³⁺, Lu³⁺, Th³⁺, and Ga³⁺.

25. The Raman active surface of claim 19 additionally comprising a neutral hydrophobic layer disposed between the Raman active metal and the peptide

26. The method of claim 19 wherein the detection of a distinctive surface enhanced Raman spectrum of the Raman active phospho affinity molecule additionally comprises depositing Raman active metal nanoparticles on the surface of the array.

27. The method of claim 26 wherein the Raman active metal nanoparticles comprise silver or gold.

28. The method of claim 26 wherein the Raman active metal nanoparticles also include LiCl.
